(19) United States
(12) Patent Application Publication
(10) Pub. No.: US 2024/0077747 A1
(43) Pub. Date: Mar. 7, 2024

(54) DISPLAY DEVICE

(71) Applicant: PanelSemi Corporation, New Taipei City (TW)

(72) Inventors: JIA-SHU WU, New Taipei City (TW); RUNG-NAN LU, New Taipei City (TW)

(21) Appl. No.: 18/460,167

(22) Filed: Sep. 1, 2023

Related U.S. Application Data
(60) Provisional application No. 63/409,365, filed on Sep. 23, 2022.
(60) Provisional application No. 63/403,039, filed on Sep. 1, 2022.

(51) Int. Cl. G02B 30/10

(52) U.S. Cl. CPC G02B 30/10

(57) ABSTRACT

A display device includes a display structure having a display surface and an actuator mechanism. The actuator mechanism drives the display structure travels along a motion path with a periodic cycle.

### CROSS REFERENCE TO RELATED APPLICATIONS

This Non-provisional application claims priority under 35 U.S.C. § 119(a) on Patent Application No(s). 63/403,039 filed in United States of America on Sep. 1, 2022, and 63/409,365 filed in United States of America on Sep. 23, 2022, the entire contents of which are hereby incorporated by reference.

### BACKGROUND

### Technology Field

The disclosure relates to a display device.

### Description of Related Art

Traditional light field technology is a sophisticated information collection technique that allows us to capture and store details of the light field, including the intensity, direction, and arrival time of light rays. This technology extends beyond the limitations of conventional two-dimensional flat images and can capture three-dimensional stereoscopic images, thereby providing a more realistic visual experience.

The crux of light field technology lies in its resolution. The higher the resolution, the more realistic the reconstructed image. However, achieving high resolution requires the use of more precise sensors to capture a large amount of light field data, as well as powerful data processing capabilities to analyze these data. The implementation of this technology requires a high level of technical expertise and a relatively high cost.

In addition, stereoscopic imaging and holographic technologies have many similarities with light field technology, especially in the process of capturing and reconstructing three-dimensional images. However, these technologies have also encountered challenges on the path to achieving high resolution.

### SUMMARY

One or more exemplary embodiments of this disclosure are to provide a display device.

A display device comprises a display structure, an optical structure disposed at a side of the display structure, and an actuator mechanism. The optical structure includes a plural of optical elements. The display structure includes a display surface, and the display surface includes a plural of pixels respectively corresponding to the plural of optical elements. The actuator mechanism drives one or both of the display structure and the optical structure to travel along a motion path, in which the motion path defines a plural of moves in sequence, and wherein a plural of virtual images are brought up in response to each of the moves.

In one embodiment, each pixels comprises at least one light emitting element.

In one embodiment, each virtual image per move defines a plural of angle-view image in correspondence with a plural of angles due to one or ones of optical members.

In one embodiment, the actuator mechanism drives at least one of the display structure or the plural optical elements traveling along the motion path with a periodical cycle.

In one embodiment, a resolution of the virtual image is multiple times of a resolution of the display structure.

In one embodiment, the actuator mechanism drives one or both of the display structure and the optical structure traveling along a motion path within a time frame, in which the motion path defines a plural of moves in sequence, and the moves are implemented within the time frame.

In one embodiment, the optical structure and the display structure define a relative-motion relationship therebetween.

In one embodiment, the motion path of the optical structure is in parallel with the motion path of the display structure.

In one embodiment, at least one projection of the motion path of the optical structure is in parallel with the motion path of the display structure.

In one embodiment, the motion path of the optical structure is in a first direction, and the motion path of the display structured is in a second direction different from the first direction. For example, the second direction is reverse to the second direction first direction.

In one embodiment, the display structure is stays still, and the optical structure travels along the motion path.

In one embodiment, the optical structure is stays still, and the display structure travels along the motion path.

In one embodiment, the display surface is common-flat or curved-planed.

In one embodiment, the optical structure includes a micro-lens array, a projecting lens-array unit accompanied with a multiple-lens system, a metasurface layer, a grating or a lenticular lens assembly.

In one embodiment, each of the optical elements is a single component or an assembly comprising multiple elements.

In one embodiment, the motion path is a straight line, a curved line or a combination thereof.

In one embodiment, an original image provided by the pixels of the display structure altered per move.

### BRIEF DESCRIPTION OF THE DRAWINGS

The present invention will become more fully understood from the subsequent detailed description and accompanying drawings, which are given by way of illustration only, and thus are not limitative of the present invention, and wherein:

FIG. 1(A) is a schematic diagram showing one embodiment of the present invention;

FIG. 1(B) and FIG. 1(C) are side views showing one embodiment of the present invention;

FIG. 2(A) and FIG. 2(B) are top views of two other embodiments of the present invention;

FIG. 3(A), FIG. 3(B) and FIG. 3(C) are schematic diagrams showing three correspondence types between the pixels and the optical elements;

FIG. 4 is a schematic diagram showing the light from the pixels is refracted after passing the corresponding optical element;

FIG. 5 is a schematic diagram showing the optical structure rotates relative to the display structure in one embodiment of the present invention;

FIG. 6(A) and FIG. 6(B-1) to FIG. 6(B-7) are schematic diagrams showing a display structure travels along a linear path;

FIG. 7(A) FIG. 7(B), FIG. 7(C) and FIG. 7(D) are a series diagram showing how one pixel of a display surface is moved in one periodical cycle;

FIG. 8(A), FIG. 8(B), FIG. 8(C) and FIG. 8(D) are four schematic diagrams showing how one pixel or pixels of a display surface is/are moved in one periodical cycle;

FIG. 9(A) and FIG. 9(B) are schematic diagrams showing relative rotation between a cylindrical display structure and its corresponding optical structure;

FIG. 9(C) is a schematic diagrams showing pixels and corresponding optical elements of one display device are arranged in a staggered manner;

FIG. 10(A) to FIG. 10(C) are three top views showing the display structure in the invention can be driven by guiding element(s);

FIG. 11(A) to FIG. 11(D) are four schematic diagrams showing how the present invention is utilized;

FIG. 12 is a schematic diagram showing a display device in one embodiment is dome-shaped; and

FIG. 13 is a schematic diagram showing a cylindrical display structure in one embodiment is composed of multiple flexible displays.

### DETAILED DESCRIPTION OF THE DISCLOSURE

The disclosure will become more fully understood from the detailed description and accompanying drawings, which are given for illustration only, and thus are not limitative of the present disclosure.

The present disclosure will be apparent from the following detailed description, which proceeds with reference to the accompanying drawings, wherein the same references relate to the same elements.

The present invention relates to a display device. The display device mainly comprises a display structure, an optical structure disposed at a side of the display structure, and an actuator mechanism.

The optical structure includes a plural of optical elements.

The display structure includes a display surface, and the display surface includes a plural of pixels respectively corresponding to the plural of optical elements. In addition, the pixels are arranged on the display surface in more than one dimension, and the display surface is flat or is at least one-dimensional curved. The display structure includes but not limited to a rigid display or a flexible display, and the display structure also includes, but not limited to, a flat-panel display device, a cylindrical display device or a curved display.

Further, each pixels comprises at least one light emission member. The light emission member can be a self-emission member. The self-emission member includes but bot limit to inorganic light emitting element or organic light emitting element. For example, self-emission member incudes but not limited to the light-emitting diodes (LEDs), mini-LEDs [symbol] micro-LEDs or organic LEDs (OLEDs). Besides, each of the pixels is RBG pixel format or non-RGB pixel format, and the non-RBG pixel format is pentile-pixel format or one-pixel format, where the pentile-pixel format or one-pixel format serves as a pixel missing with at least one subpixel.

The actuator mechanism drives one or both of the display structure and the optical structure to travel along a motion path cyclically. The motion path can be a 1-dimensional, a 2-dimensional or a 3-dimensional motion path. In one embodiment, the motion path could be a close loop path, such as a curve motion path, a circular motion path, an oval motion path, a polygon motion path, or the like. Furthermore, the motion path could be a reciprocating path, such as a linear motion path, a straight-line(s) motion path, or a curve motion path, and the like.

The motion path further defines a plural of moves in sequence, and a plural of virtual images are brought up in response to each of the moves. The moves can be implemented within a time frame, which indicates that all of these moves (or operations, actions or equivalent descriptions) can be carried out within a specific duration or period. One meaning of the time frame is that how long one single frame takes while the frame rate per se indicates the frequency (rate) at which consecutive images (frames) are captured or displayed. One meaning of the time frame is a set film frame or a period of time of a film.

For detailed comprehension, the actuator mechanism drives the display structure, for example, to travel, a plural of temporary images are brought up in response to each of the moves. Each temporary image per move defines a plural of angle-view images correspondence to various angles through one or ones of optical members. The angle-view image described here means an image generated by the corresponding optical structure by means of deviating an original image, the temporary image, provided by the display structure. These angle-view images at each angle are collected as each of the virtual images. In this case, a resolution of the virtual image is multiple times of a resolution of the display structure consequently.

To be noted, the optical structure and the display structure define a relative-motion relationship therebetween. For example, the optical structure could stay still and the display structure moves relative to the optical structure, and vice versa. In these cases, the motion path and a moving direction along the motion path of the display structure or the optical structure would not be limited. In other cases, both of the optical structure and the display structure are driven by the actuator mechanism.

In one case, at least one projection of the motion path of the optical structure matches (abbreviated as “Path O” in the following description) to a projection of the motion path of the display structure (abbreviated as “Path D” in the following description). For example, at least one projection of the Path O, or the substantial Path O, can be in parallel with the Path D.

When the substantial Path O is in parallel to the Path D, and the movement direction of the Path O is same as the movement direction of the Path D, the movement speed of the optical structure is different from the display structure. However, in this case, if the movement direction of the Path O is different from the movement direction of the Path D, the movement speeds of the two structures are not limited.

When any projection of the Path O does not match to the projection of the Path D, the movement direction and the movement speed are not limited.

The optical structure in this invention can deviate original images provided from the display structure into plural angle-view images in plural direction. The optical structure includes but not limited to a micro-lens array, a projecting lens-array unit accompanied with a multiple-lens system, a metasurface layer, a grating or a lenticular lens assembly. In addition, each of the optical elements of the optical structure can be a single component or an assembly comprising multiple elements, for example, the optical element can be an optical lens, or can be a lens assembly.

The following embodiments are only used to illustrate some possible types of “the display device travels along a motion path with a periodic cycle”, but not intend to limit the protection scope of the present invention.

### Embodiment 1

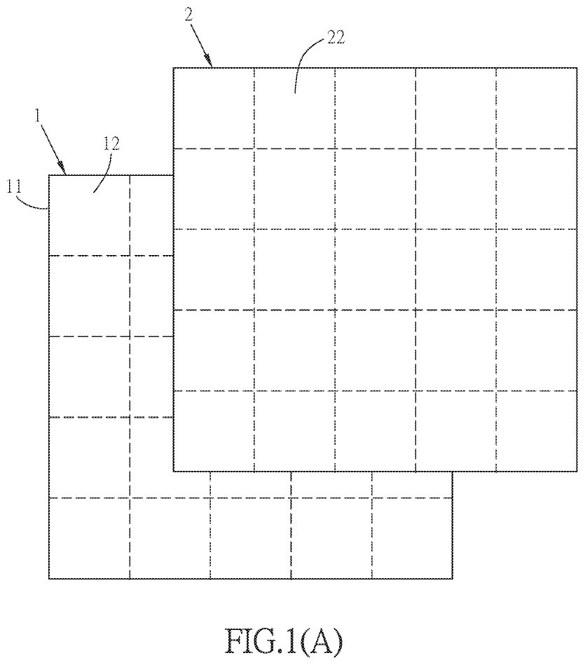

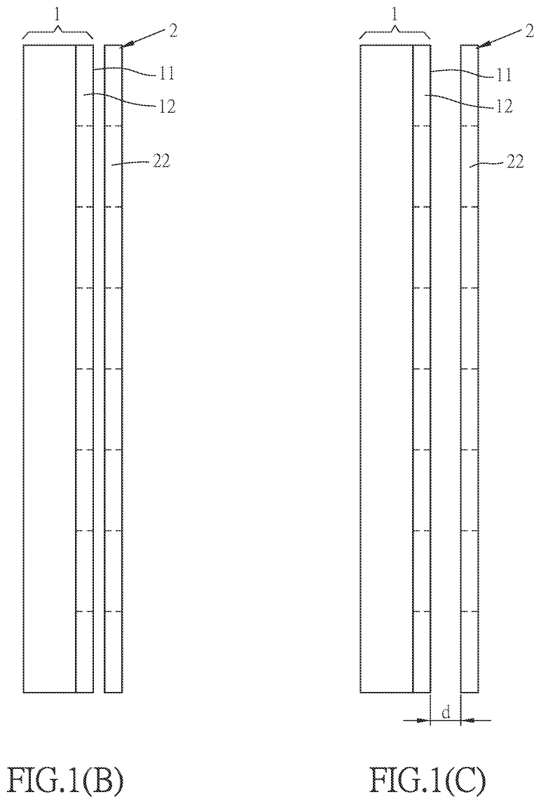

The display device of the present invention comprises a display structure 1, an optical structure 2 at one side of the display structure 1, and an actuator mechanism (not shown in FIG. 1). The display structure 1 comprises a display surface 11, and the display surface comprises one or ones of pixels 12. The optical structure 2 is disposed at one side of the display surface 11 and comprises plural optical elements 21. One or ones of the optical elements 21 correspond to one or ones of pixels 12. The optical structure can be disposed closely adjacent to the display structure as shown in FIG. 1(B) or a fixed distance d is defined between one of the pixel(s) 12 of the display structure 1 and a corresponding one of the optical element(s) 21 of the optical structure 2 in a direction perpendicular to the display structure 1 and the optical structure 2 as shown in FIG. 1(C).

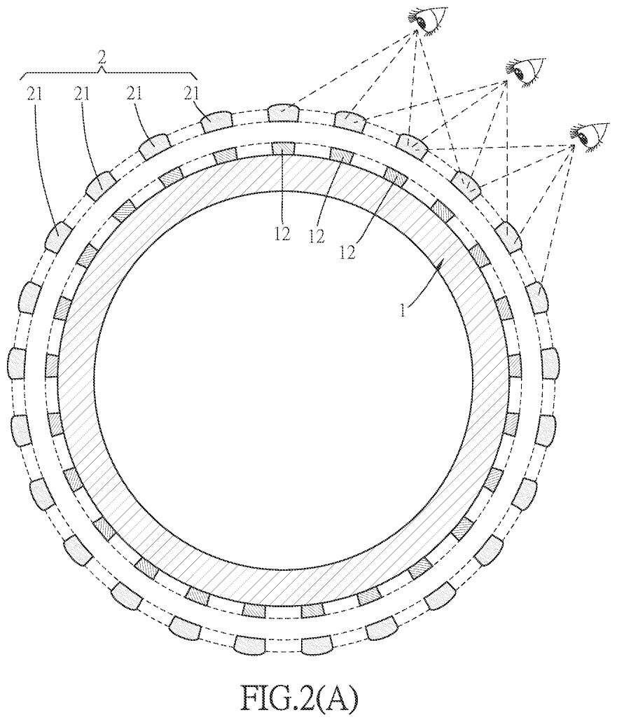

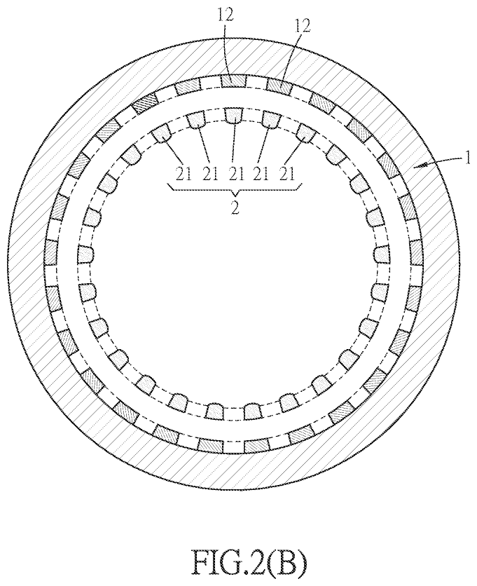

The display structure of the display device can be a flat-panel display, a cylindrical display or a curved display. In FIG. 2, the display structure is a cylindrical display. FIG. 2(A) and FIG. 2(B) are two top views showing the optical elements 21 of the optical structure 2 disposed at one site of the pixel(s) 12 of the display structure 1. Preferably, the pixel(s) 12 of the display structure is disposed at a focus of the corresponding optical element(s). The pixels 12 can be arranged at an outward surface of the cylindrical display in FIG. 2(A), or arranged at an inward surface of the cylindrical display in FIG. 2(B).

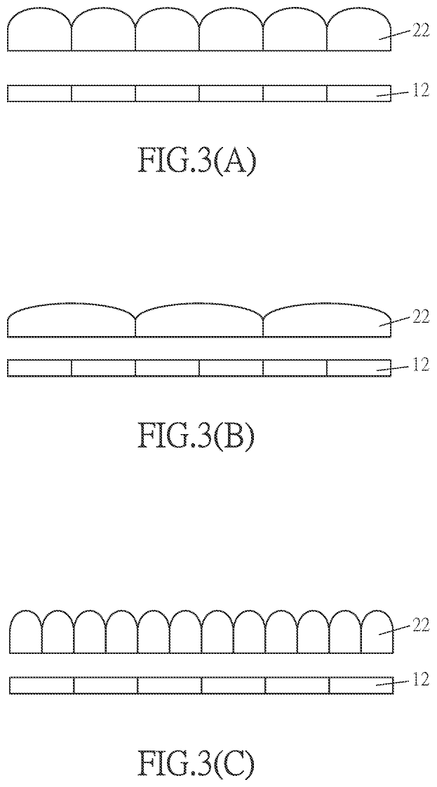

Referring to FIG. 3(A) to FIG. 3(C), the optical elements and the pixels can be arranged in a one-to-one manner, or one-to-two manner, or two-to-one manner. The above-mentioned ratio of the optical element and the pixel is just for exemplary which is not intend to limit the scope of the present invention.

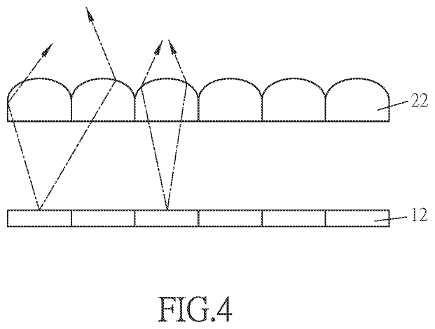

Referring to FIG. 4, the optical elements at least refract an incident light from the pixels to control a light path (represents by the arrows), the arrows in FIG. 4 is just for exemplary which is not represent a real light path of this invention. Besides, the pixel pitch and the optical element pitch of the present invention is identical to or different from each other.

Either or both of the optical structure and the display structure is driven by the actuator mechanism to travel along a motion path. The movement of the abovementioned structure can be circular and implanted within a time frame with a periodic cycle. The images or lights are provided by the pixels of the display structure, the temporary images are created per move, and the temporary images are deviated by the optical elements so as to provide virtual images with plural angles as a stereoscopic light field.

The optical structure can be connected to the display structure, particularly, movably connected to the display structure in one embodiment. The optical structure also can be individual from to the display structure in another embodiment. However, the optical structure and the display structure are connected in a relative-motion manner, and the relative-motion manner is defined with a periodical cycle and a motion path along which the optical structure or/and the display structure travels. In other words, the optical structure and the display structure can move relatively to each other, and the two structures are relative moved along a fixed motion path with a fixed periodical cycle.

The following examples are used to describe possible traveling manners of the optical structure or/and the display structure in the present invention. However, these examples do not intend to limit the scope of the present invention.

### Embodiment 2

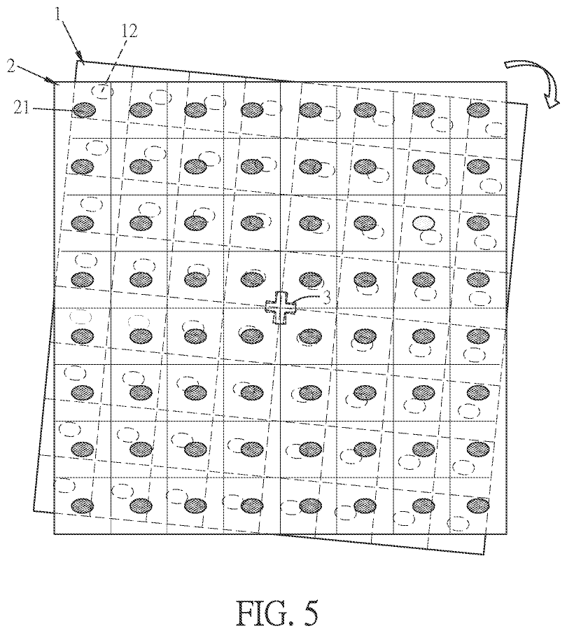

The display device in FIG. 5 is a flat-panel display structure an optical structure. One of the display structure 1 or the optical structure 2 rotates around a rotation center 3 on the display surface with a periodic cycle. The rotation center 3, in one case, is a geometric center of the display structure 1 or the optical structure 2. When the display structure 1 rotates and keeps the period of the periodical cycle no greater than a frame rate of a film of an image importing to the display structure, each pixel moves to a next position from an original position along a rotation path within a tiny period of time, an equivalent resolution while the display structure rotates is greater than an original resolution while the display structure stays still.

### Embodiment 3

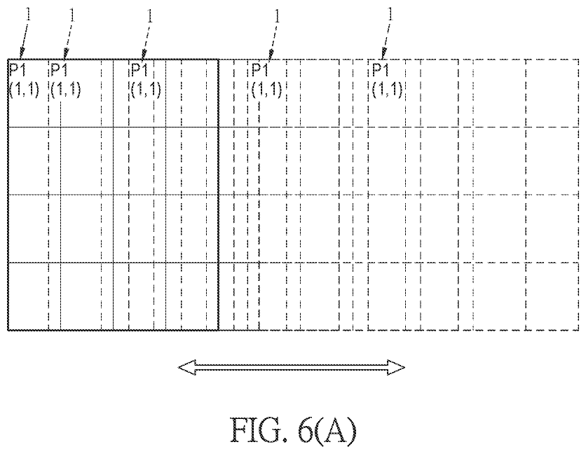

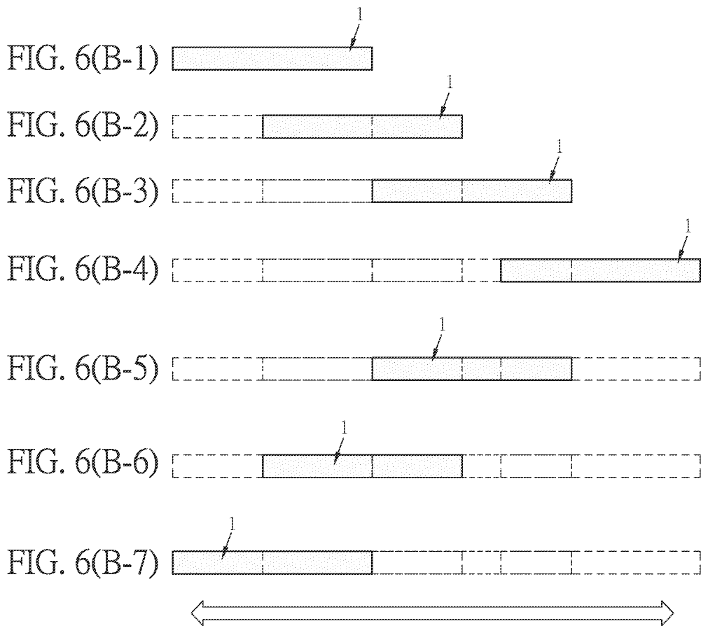

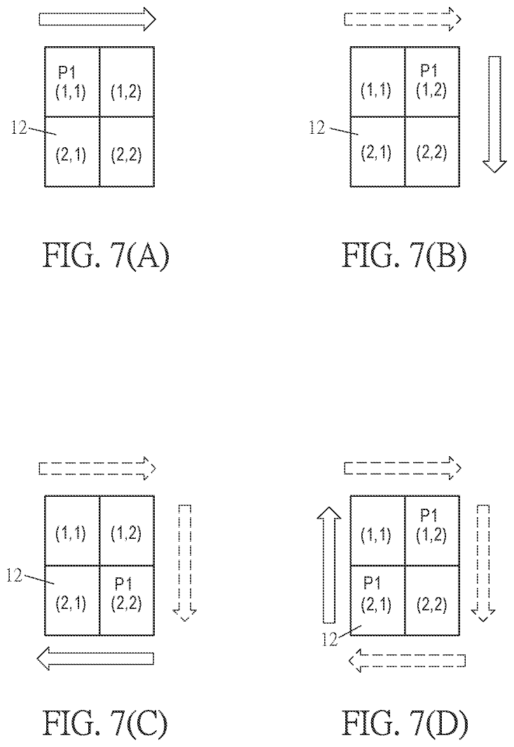

In FIG. 6, a flat-panel display structure 1 reciprocates along a linear motion path, especially a straight-line motion path. FIG. 6(A) is a top view, and FIG. 6(B-1) to FIG. 6(B-7) are side views showing how the plate-panel travels along the linear path. So, the location of the pixel P1 at the coordinate (1,1) will be moved back and forth over time. In addition, the optical structure 2 can also reciprocate along the linear path relative to the display structure 1.

### Embodiment 4

Referring FIG. 7(A) to FIG. 7(D), the pixel P1 is moved from the coordinate (1,1) and back to (1,1) by passing coordinates (1,2), (2,2) and (2,1) sequentially in one periodical cycle while the display structure 1 is driven by the actuator mechanism. For more detailed description in this case, a moving distance of each pixel 12 is equal to a single pixel pitch thereof in one movement, and the distance of the pixel 12 in one periodical cycle equals to 4 pixel pitches. In addition, the period of the periodical cycle is no greater than a frame rate of a film importing to the display structure 1. In other word, the 4 moves of the pixel make one periodical cycle in this case, and the 4 moves are completed within the frame rate of the film. If an original resolution of the display structure is Y ppi (pixels per inch), an equivalent resolution of the display device in this moving path of this embodiment then equals to Y*4^{0.5}=2Y, which indicated that the equivalent resolution is 2-times of the original resolution of this display structure 1. The equivalent resolution of the display device of the present invention is greater than the original resolution of the display structure.

In addition, when the optical structure is driven by the actuator mechanism, the position of the optical elements of the optical structure can also shifted in the manner described above.

### Embodiment 5

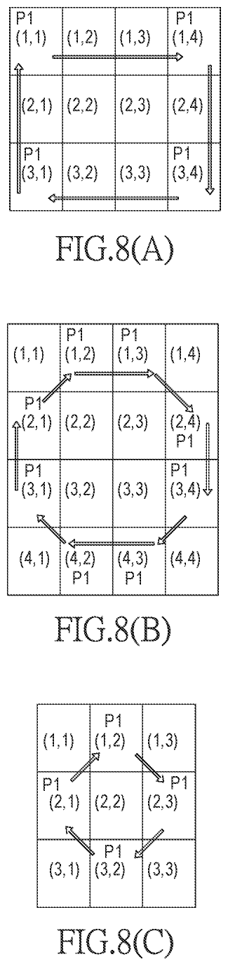

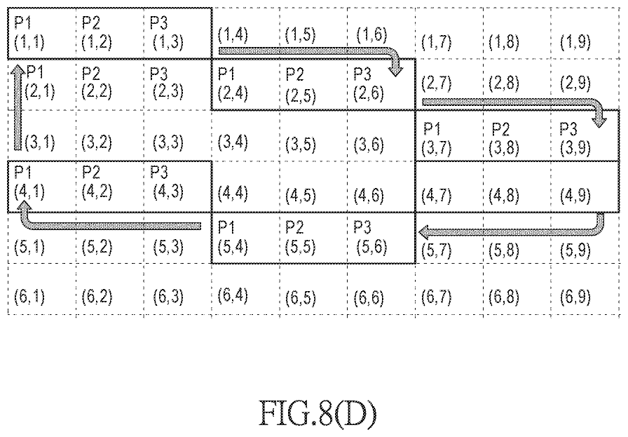

In FIG. 8(A) to FIG. 8(D), 4 scenarios are provided as examples to convey how the coordinate of the pixel P1 of the display structure is moved when the display structure is driven by the actuator mechanism. In FIG. 8(A), the pixel P1 is moved from coordinate (1, 1) and back to (1, 1) by sequentially passing coordinates (1,4), (3,4), and (3,1) in a periodic cycle. In this case, the moving distance of the pixel P1 is longer than one pixel pitch in one movement.

In addition, the pixel P1 may be moved obliquely as shown in FIG. 8(B) and FIG. 8(C). In FIG. 8(B), the pixel P1 is moved from coordinate (1,2) and back to (1,2) by sequentially passing coordinates (1,3), (2,4), (3,4), (4,3), (4,2), (3,1), and (2,1) in a periodic cycle. In FIG. 8(C), the pixel P1 is moved from coordinate (1,2) and back to (1,2) by passing coordinates (2,3), (3,2), and (2,1) in a periodic cycle.

Further, multiple pixels 12 can be grouped and moved as one unit while the display structure is driven to travel. In FIG. 8(D), the pixel P1, P2, and P3 are considered as a unit, and moved from coordinates (1,1)/(1,2)/(1,3) and back to (1,1)/(1,2)/(1,3) by sequentially passing coordinates (2,3)/(2,5)/(2,6), (3,7)/(3,8)/(3,9)/, (5,4)/(5,5)/(5,6), and (4,1)/(4,2)/(4,3) in a periodic cycle.

When the optical structure is driven by the actuator mechanism, the coordinates of the optical elements can be also shifted as the coordinate of the pixels above mentioned.

### Embodiment 6

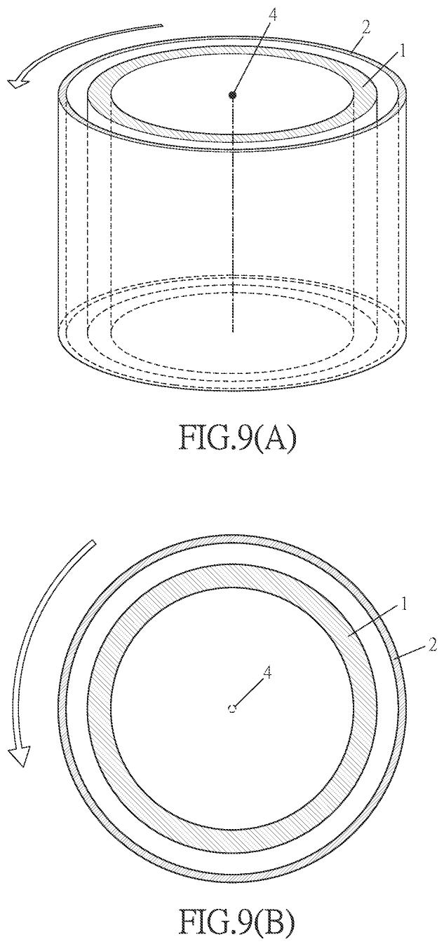

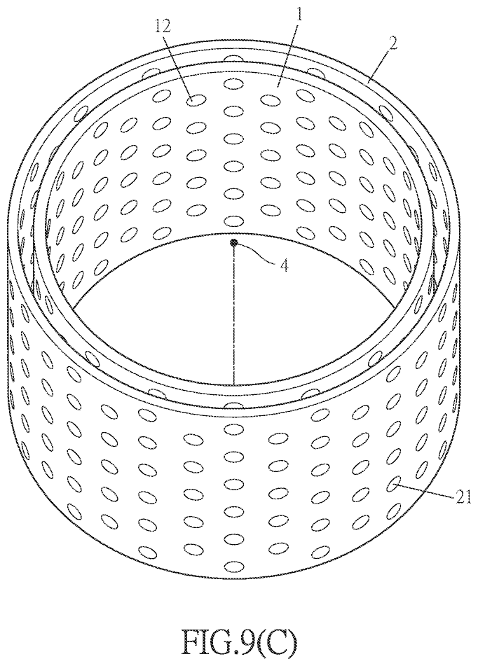

In this embodiment shown in FIG. 9, the display structure 1 is a cylindrical display structure, the display surface 11 is on the outer surface of the display structure 1, and the optical element is arranged at the outside of the display structure 1. As shown in FIG. 9(A) and FIG. 9(B), the display structure 1 or the optical structure 2 can rotate around a rotation axle 4 in which the rotation axle 4 can be a virtual axle or a substantial axle. The cylindrical display structure device can be tiled or stitched by one or ones of sub-displays, in which the sub-displays are in flexible type or not.

Referring to FIG. 9(C), the display structure is a cylindrical structure, and the pixels 12 of the display structure 1 are arranged in a staggered manner on the display surface 11. The optical elements 21 of the optical structure 2 are arranged corresponding to the pixels 12. When the cylindrical display structure rotates, an equivalent resolution in the X-direction is increased. Further, an equivalent resolution in the Y-direction is also increased due to the staggered distribution of the pixels in Y direction.

### Embodiment 7

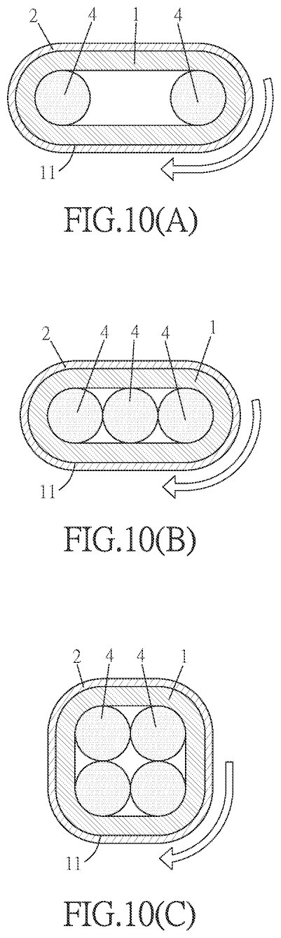

FIG. 10(A) to FIG. 10(C) are top views of three other embodiments of this invention. In these embodiments, the display structure is a flexible display structure, and the flexible display structure surrounds plural guiding elements 4. The guiding elements 4 drive the flexible display structure 1 in a specific way, such as in a rotation in this case.

### Embodiment 8

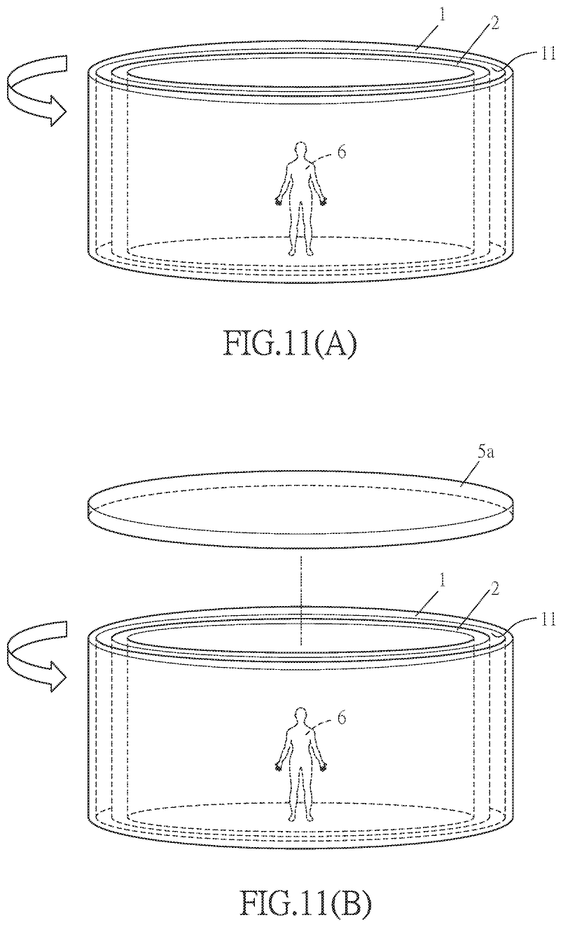

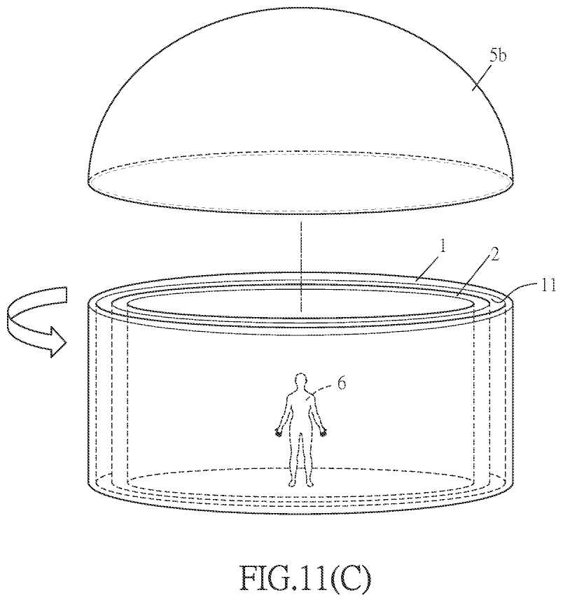

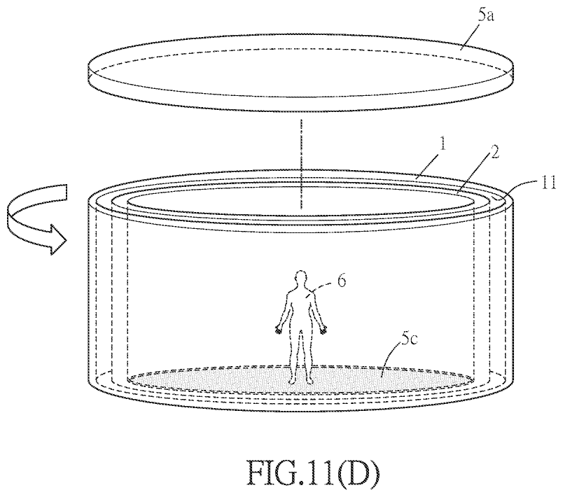

FIG. 11(A) to FIG. 11(C) shows other three embodiments of this invention. In these embodiments, the display structure are cylindrical display structures, and the display surface 11 is arranged at an inner surface of the cylindrical display structure 1. The optical 2 structure is also arranged at the inner side of the display structure 1. In these embodiments, the cylindrical display structure 1 or the optical structure 2 is capable of self-rotation. A user 6 can stay in an inner accommodation space within the cylindrical display structure to watch a film or image provided by the display device as shown is FIG. 11(A). In one case, a cover structure is added to a top of the cylindrical display device and comprises a display surface facing the inner accommodation of the cylindrical display device. As shown in FIG. 11(B) and FIG. 11(C), the cover structure could be a flat board cover structure 5a or a dome-like cover structure 5b. Furthermore, a bottom display device 5c can be applied to and disposed at a bottom of the cylindrical display structure 11 as shown in FIG. 11(D); in this case, where the user stands and keeps stable while the bottom display device turns along with the cylindrical display structure 11. To be noted, the user can be managed in the inner accommodation in any gesture or position, and not need to stand on the ground, the bottom of the cylindrical display structure 11. Either one or both of the cover structure and the bottom display device is integrated with the cylindrical display structure 11 in once piece.

### Embodiment 9

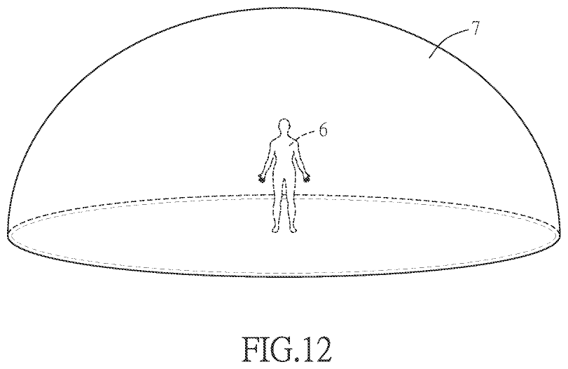

In this embodiment, the display structure is a dome-like structure 7 as shown in FIG. 12, and the display structure 1 is disposed on an inner surface of the dome-like structure 7. The user 6 can watch a film under or inside an inner accommodation surrounded the dome-like display structure.

### Embodiment 10

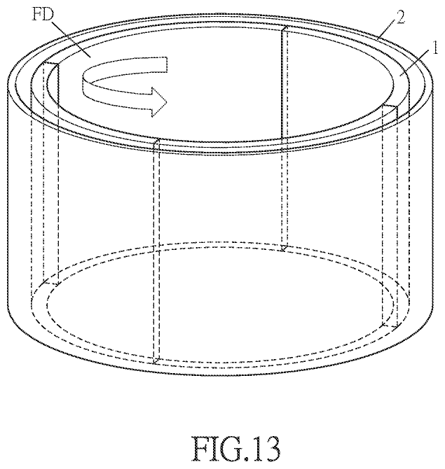

Referring to FIG. 13, a cylindrical display device is provided in this embodiment. The cylindrical display device is composed of 4 rectangle flexible displays FD and an optical structure is provided at one side of the 4 rectangle flexible displays FD. For more detailed description in this case, a resolution of each of the rectangle flexible display FD is 135 pixels (widths) multiple 120 pixels (height). An average frame rate of 30 fps is appropriate for a user to comfortably watch dynamic pictures. In this embodiment, the cylindrical display just needs to rotate at 7.5 HZ to achieve a 30 fps-frame rate since the cylindrical display device is composed of 4 flexible displays (30/4=7.5). Further, 135 pixels are arranged horizontal on each of the flexible display. When the cylindrical display device rotates ¼ turn at 7.5 HZ, 135 angels or images are provided at one position with a 30 fps-frame rate.

Accordingly, this invention relates to a display device includes a set of components: a display structure, an optical structure arranged adjacent to the display structure, and n actuator mechanism. The optical structure has plural optical elements, while the display structure incorporates a display surface that has plural pixels. Each pixel on the display surface corresponds to one or ones of the optical elements of the optical structure. The actuator mechanism guides either or both of the display and optical modules to move along a particular trajectory, a motion path defined in the present invention. This motion path is further defined by a series of movements in a certain order. As the actuator mechanism guides the display structure and/or the optical structure travels along the motion path, a series of virtual images is produced, with each move or movement in the sequence eliciting a different virtual image. In other words, each discrete move or movement in the sequence initiates the creation of a distinct virtual image. Furthermore, each virtual image is capable of perceptibility at multiple individual viewing angles. In summary, the precise nature and use of these virtual images would be reliant on the specifics of the technology employed but could encompass a range of applications from entertainment to scientific data visualization.

What is claimed is:

1. A display device, comprising:
a display structure;
an optical structure disposed at a side of the display structure; and
an actuator mechanism;
wherein the optical structure includes a plural of optical elements, the display structure includes a display surface, and the display surface includes a plural of pixels respectively corresponding to the plural of optical elements;
wherein the actuator mechanism drives one or both of the display structure and the optical structure to travel along a motion path, in which the motion path defines a plural of moves in sequence; and a plural of virtual images are brought up in response to each of the moves.

2. The display device as claimed in claim 1, each virtual image per move defines a plural of angle-view image in correspondence with a plural of angles due to one or ones of optical members.

3. The display device as claimed in claim 1, wherein the actuator mechanism drives at least one of the display structure or the plural optical elements traveling along the motion path with a periodical cycle.

4. The display device as claimed in claim 3, wherein a resolution of the virtual image is multiple times of a resolution of the display structure.

5. The display device as claimed in claim 1, wherein the actuator mechanism drives one or both of the display structure and the optical structure traveling along a motion path within a time frame, in which the motion path defines a plural of moves in sequence, and the moves are implemented within the time frame.

6. The display device as claimed in claim 1, wherein the optical structure and the display structure define a relative-motion relationship therebetween.

7. The display device as claimed in claim 5, wherein the motion path of the optical structure is in parallel with the motion path of the display structure.

8. The display device as claimed in claim 5, wherein at least one projection of the motion path of the optical structure is in parallel with the motion path of the display structure.

9. The display device as claimed in claim 5, wherein the motion path of the optical structure is in a first direction, and the motion path of the display structured is in a second direction different from the first direction.

10. The display device as claimed in claim 9, wherein the motion path of the optical structure is in a first direction, and the motion path of the display structured is in a second reverse to the first direction.

11. The display device as claimed in claim 1, wherein the display structure stays still, and the optical structure travels along the motion path.

12. The display device as claimed in claim 1, wherein the optical structure stays still, and the display structure travels along the motion path.

13. The display device as claimed in claim 1, wherein the display surface is common-flat or curved-planed.

14. The display device as claimed in claim 1, wherein the optical structure includes a micro-lens array, a projecting lens-array unit accompanied with a multiple-lens system, a metasurface layer, a grating or a lenticular lens assembly.

15. The display device as claimed in claim 1, wherein each of the optical elements is a single component or an assembly comprising multiple elements.

16. The display device as claimed in claim 1, wherein the motion path is a straight line, a curved line or a combination thereof.

17. The display device as claimed in claim 1, wherein an original image provided by the pixels of the display structure altered per move.
